(19) United States
(12) Patent Application Publication
(10) Pub. No.: US 2015/0007784 A1
(43) Pub. Date: Jan. 8, 2015

(54) CYLINDER HEAD HAVING MULTIPLE COOLING PASSAGES

(71) Applicant: Electro-Motive Diesel Inc., LaGrange, IL (US)

(72) Inventor: Robert Thurber MacVicar, Downers Grove, IL (US)

(21) Appl. No.: 13/935,214

(22) Filed: Jul. 3, 2013

(51) Int. Cl. F02F 1/26

(52) U.S. Cl. CPC F02F 1/26
USPC 123/41.79; 123/434

(57) ABSTRACT

A cylinder head is disclosed. The cylinder head may include a body, and a lower jacket formed in a lower portion of the body. The cylinder head may also have a centrally-located fuel injector opening passing through the lower portion of the body, and a plurality of intake and exhaust valve openings spaced evenly around the fuel injector opening. The cylinder head may also include at least one inlet located between adjacent ones of the plurality of intake valve openings or between adjacent ones of the plurality of exhaust valve openings, and at least one outlet located between one of the plurality of intake valve openings and one of the plurality of exhaust valve openings. The cylinder head may further include a plurality of cooling passages surrounding the plurality of intake and exhaust valve openings, and connecting the at least one inlet and the at least one outlet.

### TECHNICAL FIELD

The present disclosure relates generally to a cylinder head, and more particularly, to a cylinder head having multiple cooling passages.

### BACKGROUND

An internal combustion engine generally includes one or more combustion chambers that house a combustion process to produce mechanical work and a flow of exhaust. Each combustion chamber is defined by a cylinder, a top surface of a piston, and a bottom surface of a cylinder head. Air or an air/fuel mixture is directed into the combustion chamber by way of intake ports in the cylinder head, and a resulting exhaust flow is discharged from the combustion chamber by way of exhaust ports also in the cylinder head. Valves are located within bores associated with the intake and exhaust ports and sealed against valve seat inserts to selectively allow and block the flows of air and exhaust through the intake and exhaust ports. In some embodiments, a fuel injector is located within the cylinder head to inject fuel with the flows of air into the combustion chamber to support fuel combustion in the engine.

During engine operation, cylinder heads, valves, valve seat inserts, and fuel injectors are exposed to high stresses and temperatures. And, over time, these high stresses and temperatures can cause excessive wear of these components.

One solution to the high stresses and temperatures described above is disclosed in U.S. Pat. No. 5,745,993 (“the '993 patent”) that issued to Adachi et at on May 5, 1998. The '993 patent describes a reciprocating machine having a cylinder head including intake and exhaust flow passages that are controlled by intake and exhaust poppet-type valves. Each valve has a head portion that cooperates with a respective valve seat formed at lower ends of the intake and exhaust flow passages. The cylinder head utilizes a valve insert ring to form the valve seat that is press-fit within each flow passage. One or more water jackets are formed within the cylinder head and provide cooling for the cylinder head, the valves, the valve insert rings, and/or an associated fuel injector.

Although the water jackets of the '993 patent help to provide some cooling for the cylinder head, the valves, the valve insert rings, and the fuel injector, it may still be less than optimal. Specifically, the water jackets of the '993 patent are located a distance from the valves, the valve insert rings, and the fuel injector, and this distance may limit the amount of heat that can transfer from these components to coolant in the water jackets.

The cylinder head of the present disclosure solves one or more of the problems set forth above and/or other problems with existing technologies.

### SUMMARY OF THE DISCLOSURE

In one aspect, the present disclosure is directed to a cylinder head. The cylinder head may include a body, and a lower jacket formed in a lower portion of the body. The cylinder head may also have a centrally-located fuel injector opening passing through the lower portion of the body, and a plurality of intake and exhaust valve openings spaced evenly around the fuel injector opening. The cylinder head may also include at least one inlet located between an adjacent pair of the plurality of intake valve openings or between an adjacent pair of the plurality of exhaust valve openings, and at least one outlet located between one of the plurality of intake valve openings and one of the plurality of exhaust valve openings. The cylinder head may further include a plurality of cooling passages surrounding the plurality of intake and exhaust valve openings, and connecting the at least one inlet and the at least one outlet.

In another aspect, the present disclosure is directed to a method of cooling a cylinder head. The method may include directing coolant into the cylinder head. The method may also include dividing the coolant into two substantially equal flow streams at a location between two similar valves openings, and subdividing each of the two flow streams into two more flow streams extending around each of the two similar valves openings. The method may further include rejoining each of the subdivided flow streams back together, and joining each of the rejoined flows with a separate flow at locations between two dissimilar valve openings.

### BRIEF DESCRIPTION OF THE DRAWINGS

FIG. 1 is a pictorial illustration of an exemplary disclosed engine;

FIG. 2 is a pictorial illustration of an exemplary disclosed cylinder head assembly that may be utilized in conjunction with the engine of FIG. 1;

FIG. 3 is a cross-sectional view illustration taken along line 3-3 of the cylinder head assembly of FIG. 2;

FIG. 4 is a cross-sectional view illustration taken along line 4-4 of the cylinder head assembly of FIG. 2;

FIG. 5 is a cross-sectional end view illustration taken along line 5-5 of the cylinder head assembly of FIG. 2; and

FIG. 6 is a cross-sectional end view illustration of an alternative embodiment of the cylinder head assembly of FIG. 5.

### DETAILED DESCRIPTION

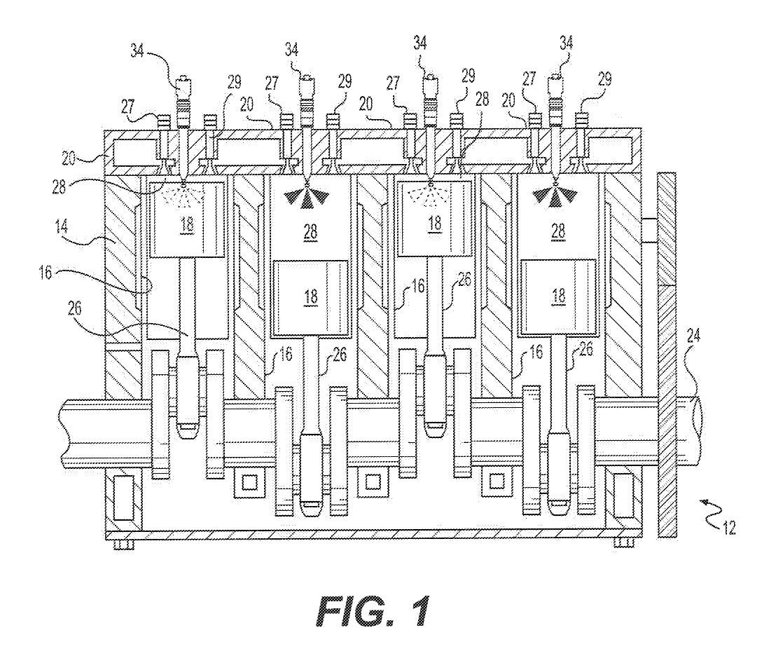

FIG. 1 illustrates an exemplary engine 12. For the purposes of this disclosure, engine 12 is depicted and described as a four-stroke diesel engine. One skilled in the art will recognize, however, that engine 12 may be any other type of combustion engine such as, for example, a two or tour-stroke gasoline or gaseous fuel-powered engine.

Engine 12 may include an engine block 14 that at least partially defines a plurality of cylinders 16. A piston 18 may be slidably disposed within each cylinder 16 to reciprocate between a top-dead-center position and a bottom-dead-center position, and a cylinder head 20 may be associated with each cylinder 16. Each cylinder 16, piston 18, and cylinder head 20 may together at least partially define a combustion chamber 28. A fuel injector 34 may be at least partially disposed within each cylinder head 20 and configured to inject fuel into each respective combustion chamber 28 to support fuel combustion within engine 12. One or more intake and exhaust valves 27, 29 may also be at least partially disposed within cylinder head 20 and configured to selectively allow and block flows of air and exhaust into and out of combustion chamber 28. Engine 12 may also include a crankshaft 24 that is rotatably supported within engine block 14 by way of a plurality of journal bearings (not shown). A connecting rod 26 may connect each piston 18 to crankshaft 24 so that a sliding motion of piston 18 within each respective cylinder 16 results in a rotation of crankshaft 24.

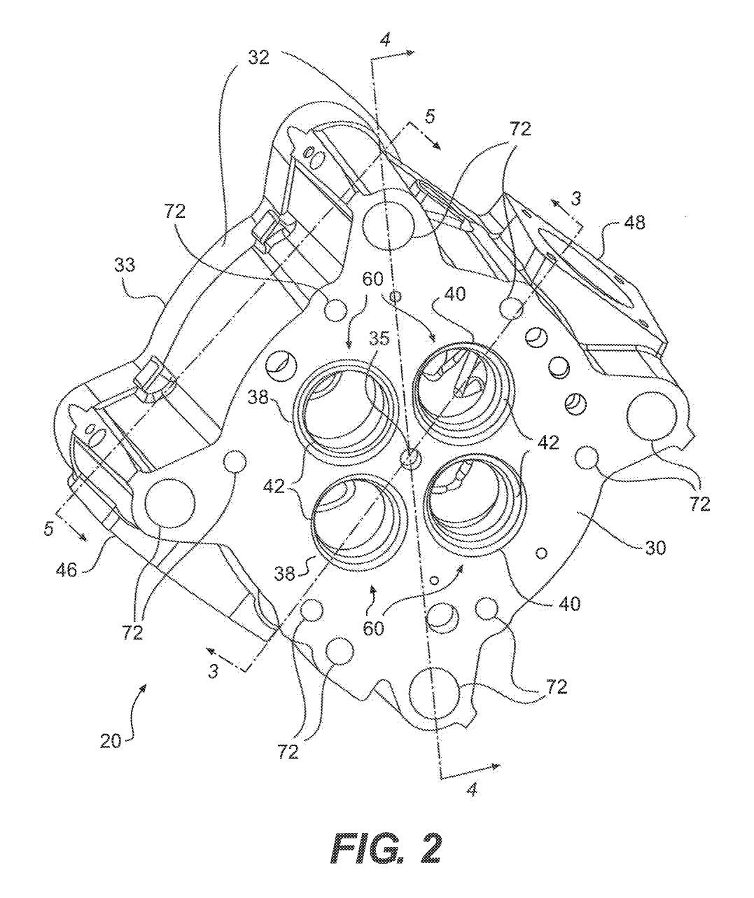

As shown in FIG. 2, cylinder head 20 may include a body having a bottom deck, or firedeck surface 30, a plurality of side surfaces 32, and a top surface 33. Firedeck surface 30 of cylinder head 20 may include a centrally-located fuel injector opening 35 associated with fuel injector 34 and two or more valve openings. In the embodiment shown, the valve openings include a pair of similar intake valve openings 38 and a pair of similar exhaust valve openings 40. It is contemplated that intake valve openings 38 may be dissimilar to exhaust valve openings 40. It is also contemplated that, in some embodiments, firedeck surface 30 may have only one intake valve opening 38 and/or one exhaust valve opening 40. Valve openings 38, 40 may be evenly spaced around fuel injector opening 35. A passage (not shown) may be defined within cylinder head 20 extending from each valve opening 38, 40 to a respective one of an intake port 46 and an exhaust port 48. Intake and exhaust ports 46, 48 may be disposed in side surfaces 32 of cylinder head 20 to allow air and exhaust to enter and exit cylinder head 20. In some embodiments, one or more mounting holes 72 may be disposed within cylinder head 20 and be configured to attach cylinder head 20 to engine block 14 (referring to FIG. 1) using a plurality of bolts, or by any other form of attachment known in the art.

Also shown in FIG. 2, cylinder head 20 may have a stepped bore 60 associated with each valve opening 38, 40. A generally circular or ring-shaped valve seat insert 42 may be pressed into each stepped bore 60 and provide a seating surface for a respective one of intake valve 27 or exhaust valve 29 (shown in FIG. 1). During engine operation, valve seat inserts 42 may serve to protect cylinder head 20 from excessive wear and/or corrosion resulting from contact with intake and exhaust valves 27, 29. Valve seat inserts 42 may also provide a tight seal with intake and exhaust valves 27, 29 to selectively block unintended leakage of air and exhaust into or out of combustion chamber 28 (referring to FIG. 1).

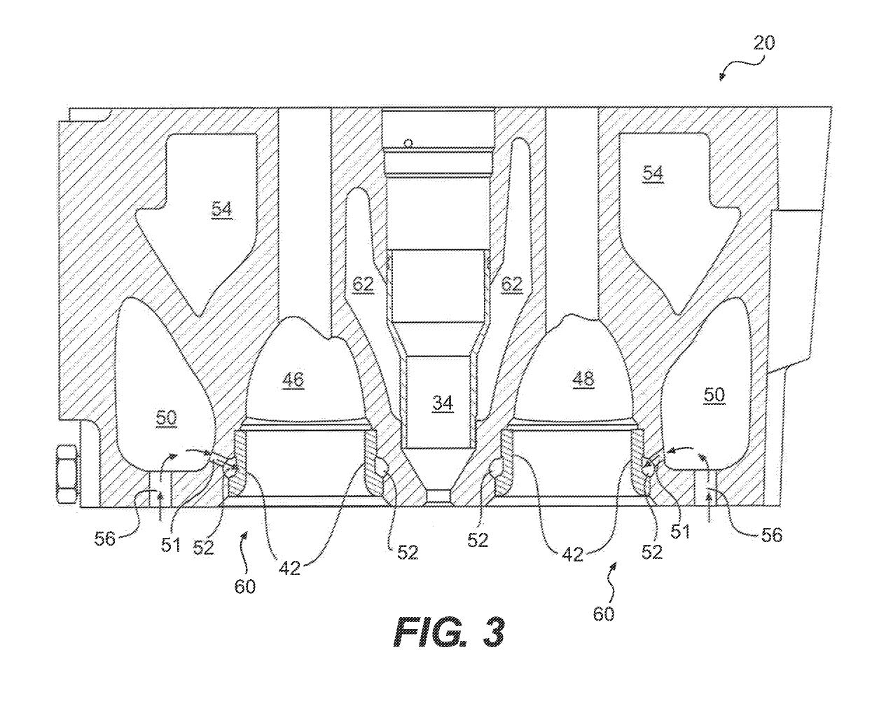

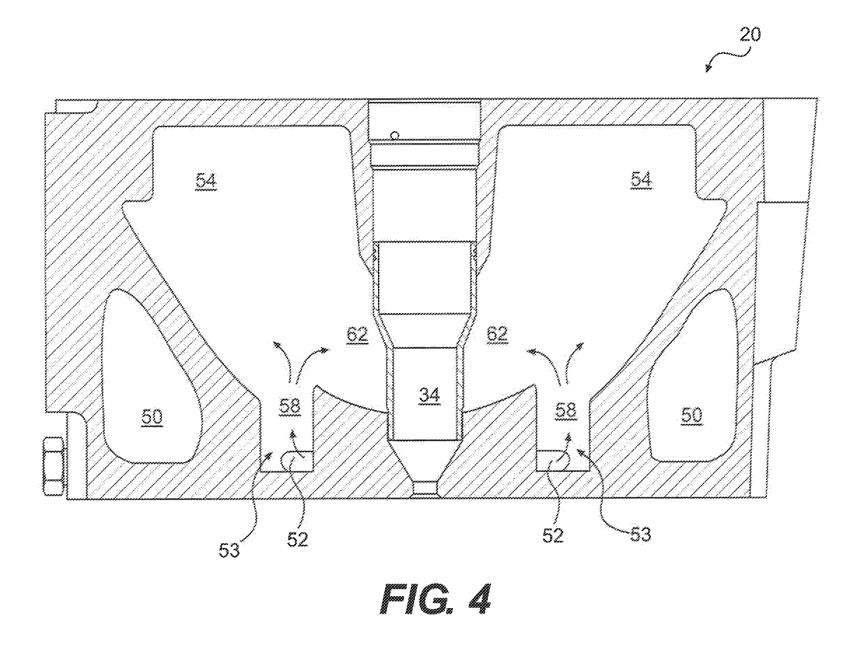

FIGS. 3 and 4 illustrate cross sectional view illustrations taken along lines 3-3 and 4-4 of cylinder head 20 shown in FIG. 2, respectively. Internally, cylinder head 20 may include a plurality of cooling passages configured to facilitate the transfer of thermal energy away from cylinder head 20, intake and exhaust valves 27, 29, valve seat inserts 42, and/or fuel injector 34. The cooling passages may include, for example, water jackets that utilize a coolant, such as glycol, water, a water/glycol mixture, or another coolant known in the art.

In the disclosed embodiment, cylinder head 20 includes a lower jacket 50 and an upper jacket 54 formed in lower and upper portions of cylinder head 20, respectively. Lower and upper jackets 50, 54 may be separated by a substantially horizontal partition (not shown). Lower and upper jackets 50, 54 may function as distribution passages, and connect to multiple smaller cooling passages located throughout cylinder head 20. For example, lower and upper jackets 50, 54 may connect to multiple annular cooling passages 52 that substantially surround one or more valve seat inserts 42. Each cooling passage 52 may entirely surround a periphery of each respective valve seat insert 42 associated with one of intake or exhaust valve openings 38, 40. Cooling passages 52 may provide cooling to their respective valve seat inserts 42 and/or intake or exhaust valves 27, 29. In addition, cooling passages 52 may be used to transfer coolant from lower jacket 50 to upper jacket 54. It is contemplated that cooling passages 52 may be the only paths through which coolant can flow directly between lower jacket 50 and upper jacket 54.

As shown in FIG. 3, lower jacket 50 may be fluidly connected to one or more inlet passages 56, which, in turn, may be connected to one or more cooling passages located in a cylinder liner associated with cylinder 16. Lower jacket 50 may also be fluidly connected to cooling passages 52 via a pair of inlets 51 located at separate locations around fuel injector 34. Lower jacket 50 may be configured to receive coolant from inlet passages 56 and direct coolant into cooling passages 52 via inlets 51.

As shown in FIG. 4, cooling passages 52 may be fluidly connected to one or more vertical passages 58 via a pair of outlets 53 located at separate locations around fuel injector 34. Upper jacket 54 may be in fluid communication with cooling passages 52 via vertical passages 58. Upper jacket 54 may also be fluidly connected to cooling passages 62 that substantially surround fuel injector 34. It is contemplated that cooling passages 62 may be connected with upper jacket 54 separately from cooling passages 52, for reasons described in more detail below. Upper jacket 54 may be configured to receive coolant from coolant passages 52 via vertical passages 58 and direct coolant into cooling passages 62. The coolant may then flow out of cylinder head 20 through one or more outlet passages (not shown).

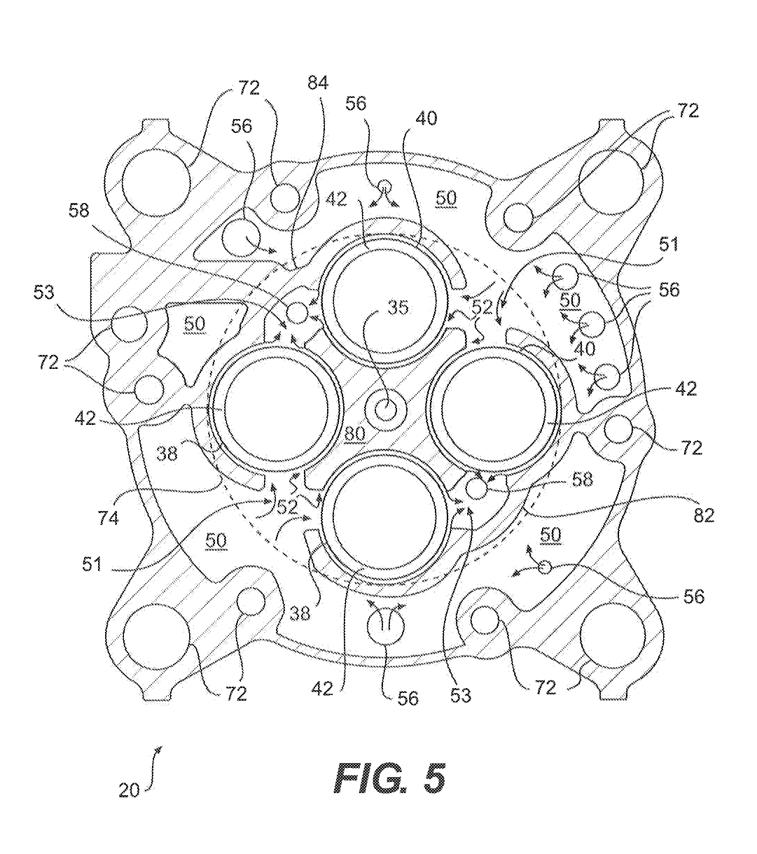

FIG. 5 illustrates a cross sectional end view illustration taken along line 5-5 of cylinder head 20 shown in FIG. 2. As shown in FIG. 5, inlet passages 56 may be located at outer edges of cylinder head 20, radially outward of a fireface region 74 of firedeck surface 30 (i.e., a portion of firedeck surface 30 exposed to combustion chamber 28). Such positioning may allow inlet passages 56 to connect directly to the cooling passages within the cylinder liner at locations not exposed to combustion chamber 28. There are seven inlet passages 56 shown in FIG. 4, however, any number of inlet passages 56 may be utilized, as desired.

Traditionally, cooling passages associated with valve seat inserts 42 extend fully into the center of cylinder head 20, such that fuel injector 34 receives direct cooling from these cooling passages. However, routing cooling passages into the center of cylinder head 20 to cool fuel injector 34 can be problematic in some situations. Such a routing configuration requires additional sealing of a fuel injector sleeve associated with fuel injector 34 to prevent coolant from leaking into combustion chamber 28, resulting in additional machining and costs. Further, this configuration can cause high stresses at the center of cylinder head 20, leading to excessive wear of cylinder head 20, fuel injector 34, and/or the fuel injector sleeve.

In order to help reduce stresses associated with routing these cooling passages, in the disclosed embodiment, inlets 51 and outlets 53 to and from cooling passages 52 are located outside of the center of cylinder head 20. In particular, as shown in FIG. 5, inlets 51 and outlets 53 may be spaced a distance away from the center of cylinder head 20. In one embodiment, inlets 51 and 53 may be spaced apart from the center of cylinder head 20 at a distance of about two-thirds of a radius of fireface region 74. This distance may help to reduce the likelihood of stress and cracking in the center of cylinder head 20.

As shown in FIG. 5, each inlet 51 may be located about 90° radially apart from adjacent outlets 53, with respect to fuel injector opening 35. Also, inlets 51 and outlets 53 may be located on opposite sides of valve seat inserts 42, such that coolant flows from a single inlet 51 in two separate paths around each valve seat insert 42 to outlets 53. Each of the two paths may split into pairs to form four total flow paths from each inlet 51. Each pair of flow paths may together surround the periphery of each valve seat insert 42 (i.e. each path of each pair may flow on one side of an associated valve seat insert 42).

In some embodiments, one inlet 51 may be located between the pair of intake valve openings 38, while another inlet 51 may be located between the pair of exhaust valve openings 40. On the other hand, each outlet 53 may be located between one intake valve opening 38 and one exhaust valve opening 40. In the disclosed embodiment, each inlet 51 may be configured to receive coolant from the lower jacket 53, divide the coolant between two similar adjacent valve openings 38, 40, and subdivide the coolant at each valve opening 38, 40 to flow around each valve seat insert 42 in two separate flow streams. Each outlet 53 may be configured to receive coolant from two dissimilar adjacent valve openings 38, 40 and direct the coolant upwards in a single flow stream via vertical passage 58.

Also shown in FIG. 5, cylinder head 20 may include a plurality of protrusions at least partially defining inlets 51 and outlets 53, and separating inlets 51 and outlets 53 from the center of cylinder head 20. A first protrusion 80 may be generally X-shaped and surround fuel injector opening 35. Protrusion 80 may include four legs, each leg extending between adjacent valve openings 38, 40 to a location at least past a centerline of the valve openings 38, 40. Between the legs, protrusion 80 may include a plurality of substantially concave surfaces forming at least part of cooling passages 52. A second, arm-like protrusion 82 may surround two adjacent valve openings 38, 40. Protrusion 82 may have a first end at least partially forming one inlet 51, and a second end at least partially forming another inlet 51. A center of protrusion 82 may at least partially form one outlet 53. A third, arm-like protrusion 84 may be substantially similar to protrusion 82, however, protrusion 84 may be located opposite protrusion 82 and surround two different valve openings 38, 40.

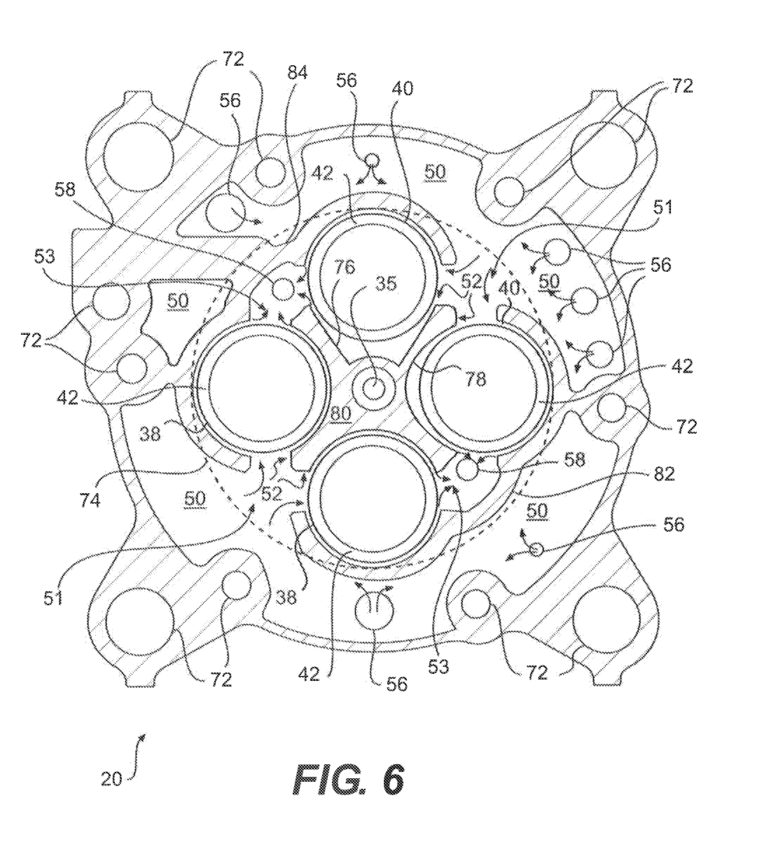

FIG. 6 illustrates a cross-sectional end view illustration of an alternative embodiment of the cylinder head assembly of FIG. 5. As shown in FIG. 6, protrusion 80 may be modified to allow coolant to flow closer to fuel injector 34. For instance, a first exemplary recess 76 may be formed asymmetrically at only one side of protrusion 80. In the embodiment shown in FIG. 6, recess 76 may be generally non-circular and have a substantially convex inner surface located closest to fuel injector 34 that conforms to a shape of fuel injector opening 35. A second exemplary recess 78 may be formed within protrusion 80 that is generally elliptically-shaped and concentric with respect to its associated valve opening 38, 40. Recess 78 may have a substantially concave inner surface located closest to fuel injector 34.

Recesses 76, 78 may create a gap that extends a distance of about 5-10% of a diameter of each respective valve opening 38, 40. This gap may create a cooling pocket between fuel injector 34 and the corresponding intake or exhaust valve 27, 29. The use of recesses 76, 78 may provide additional cooling to cylinder head 20 and/or fuel injector 34 by increasing a volume of cooling passages 52 and positioning cooling passages 52 closer to fuel injector 34. This additional cooling may reduce stresses and temperatures of fuel injector 34 and/or at the center of cylinder head 20. The use of recesses 76, 78 may also help to provide a uniform temperature distribution across fireface region 74, thereby reducing thermal stresses across fireface region 74.

In some embodiments, recesses 76, 78 may be associated only with exhaust valve openings 40. This configuration may help to reduce a temperature of the respective exhaust valves 29, which can be substantially hotter than intake valves 27. However, it is contemplated that, in other embodiments, recesses 76, 78 may be associated with one or both of intake and exhaust valve openings 38, 40. It is also contemplated that protrusion 80 may include recesses with other asymmetric geometrical features that provide additional cooling to fuel injector 34 and/or cylinder head 20. It is further contemplated that protrusion 80 may include any number of recesses 76, 78. Both recesses 76, 78 are shown in FIG. 5 merely for consolidation of the drawings used to depict the different embodiments of the disclosed cylinder head.

### INDUSTRIAL APPLICABILITY

The disclosed cylinder head may be implemented into any engine application where engine cooling is utilized. Cooling passages 52 may route coolant from lower jacket 50 to upper jacket 54 at locations away from the center of cylinder head 20, thereby helping to reduce stresses in the center of cylinder head 20. In addition, asymmetrical recesses 76, 78 may position cooling passages 52 closer to fuel injector 34, thereby providing additional cooling to fuel injector 34. The flow of coolant through the disclosed cylinder head will now be described below.

Referring to FIG. 3, coolant may be directed into cylinder head 20 from cylinder liner 18 via inlet passages 56. Within cylinder head 20, the coolant may enter lower jacket 50 and circulate from the outer edges of cylinder head 20 towards the center of cylinder head 20. The coolant from lower jacket 50 may be directed into cooling passages 52 surrounding valve seat inserts 42 via inlets 51.

Referring to FIG. 5, at inlets 51, coolant may be divided into two substantially equal flow streams prior to entering adjacent cooling passages 52 associated with one of intake or exhaust valve openings 38, 40. At each valve opening 38, 40, coolant may again be divided into two substantially equal flow streams prior to flowing around valve seat inserts 42. The coolant flowing around each valve seat insert 42 may be rejoined at outlets 53.

Referring to FIG. 4, at outlets 53, coolant from one intake valve opening 38 and coolant from one exhaust valve opening 40 may be joined into a single flow stream. The coolant may then be redirected upward about 90° into upper jacket 54 through vertical passages 58. The coolant flowing through lower jacket 50, cooling passages 52, and upper jacket 54 may absorb thermal energy from cylinder head 20, intake and exhaust valves 27, 29, valve seat inserts 42, and/or fuel injector 34. The coolant may then continue from upper jacket 54 out of cylinder head 20 and to additional cooling components of engine 12.

It will be apparent to those skilled in the art that various modifications and variations can be made to the disclosed cylinder head. Other embodiments will be apparent to those skilled in the art from consideration of the specification and practice of the disclosed cylinder head assembly. It is intended that the specification and examples be considered as exemplary only, with a true scope being indicated by the following claims and their equivalents.

What is claimed is:

1. A cylinder head for an engine, comprising:
a body;
a lower jacket formed in a lower portion of the body;
a centrally-located fuel injector opening passing through the lower portion of the body;
a plurality of intake valve openings spaced around the fuel injector opening;
a plurality of exhaust valve openings spaced around the fuel injector opening;
at least one inlet located between at least one of an adjacent pair of the plurality of intake valve openings or an adjacent pair of the plurality of exhaust valve openings;
at least one outlet located between one of the plurality of intake valve openings and one of the plurality of exhaust valve openings; and
a plurality of cooling passages surrounding the plurality of intake and exhaust valve openings, and connecting the at least one inlet and the at least one outlet.

2. The cylinder head of claim 1, further including a generally X-shaped protrusion located at a center of the body and surrounding the fuel injector opening, the generally X-shaped protrusion separating the plurality of cooling passages from the fuel injector opening.

3. The cylinder head of claim 2, wherein the generally X-shaped protrusion includes:
a plurality of legs, each leg extending at least past a centerline of one of the plurality of intake and exhaust valve openings; and
a plurality of substantially concave surfaces located between the plurality of legs, and at least partially forming the plurality of cooling passages.

4. The cylinder head of claim 1, wherein the at least one inlet includes:
a first inlet located between a pair of the plurality of intake valve openings; and
a second inlet located between a pair of the plurality of exhaust valve openings.

5. The cylinder head of claim 4, further including an arm-like protrusion surrounding a first of the plurality of intake valve openings and a first of the plurality of exhaust valve openings, the arm-like protrusion including:
a first end at least partially forming the first inlet; and
a second end at least partially forming the second inlet.

6. The cylinder head of claim 5, wherein the arm-like protrusion is a first arm-like protrusion, and the cylinder head further includes a second arm-like protrusion positioned opposite the first arm-like protrusion relative to the fuel injector opening.

7. The cylinder head of claim 4, wherein the at least one outlet includes:
a first outlet located between a first of the plurality of intake valve openings and a first of the plurality of exhaust valve openings; and
a second outlet located between a second of the plurality of intake valve openings and a second of the plurality of exhaust valve openings.

8. The cylinder head of claim 7, further including:
an upper jacket formed in an upper portion of the body; and
a pair of vertical passages connecting the upper and lower jackets.

9. The cylinder head of claim 8, wherein coolant flows from the lower jacket through the plurality of cooling passages and the pair of vertical passages to the upper jacket.

10. The cylinder head of claim 2, further including an asymmetric recess formed within the generally X-shaped protrusion.

11. The cylinder head of claim 10, wherein the asymmetric recess is generally non-circular and has a substantially convex inner surface about the fuel injector opening.

12. The cylinder head of claim 10, wherein the asymmetric recess is generally elliptically-shaped and concentric with respect to one of the plurality of intake and exhaust valve openings.

13. The cylinder head of claim 10, wherein the asymmetric recess is associated only with the plurality of exhaust valve openings.

14. The cylinder head of claim 13, wherein the asymmetric recess creates a gap that extends a distance of about 5-10% of a diameter one of the plurality of exhaust valve openings.

15. The cylinder head of claim 1, wherein the at least one inlet and the at least one outlet are located about 90° radially apart from each other with respect to the fuel injector opening, and are spaced apart a distance from the fuel injector opening of about two-thirds of a radius of a fireface region.

16. A method of cooling a cylinder head, comprising:
directing coolant into the cylinder head;
dividing the coolant into two substantially equal flow streams at a location between two similar valve openings;
subdividing each of the two flow streams into two more flow streams extending around each of the two similar valve openings; and
rejoining each of the subdivided flow streams back together;
joining each of the rejoined flows with a separate flow at locations between two dissimilar valve openings.

17. The method of claim 16, wherein extending around each of the two similar valve openings includes extending a first flow stream around about a first half of a first valve opening, and extending a second flow stream around about a second half of the first valve opening.

18. The method of claim 16, further including directing coolant from a first jacket to a second jacket at least one of the locations between dissimilar valve openings.

19. The method of claim 16, wherein directing coolant into the cylinder head includes directing coolant from one or more passages located in a cylinder liner associated with the cylinder head into multiple inlet passages located in the cylinder head at locations radially outward of an associated fireface region.

20. An engine, comprising:
an engine block at least partially defining a plurality of cylinders; and
a plurality of cylinder heads associated with the plurality of cylinders, each cylinder head including:
a body;
a lower jacket formed in a lower portion of the body;
a centrally-located fuel injector opening passing through the lower portion of the body;
a plurality of intake valve openings spaced evenly around the fuel injector opening;
a plurality of exhaust valve openings spaced evenly around the fuel injector opening;
at least one inlet located between at least one of an adjacent pair of the plurality of intake valve openings or an adjacent pair of the plurality of exhaust valve openings;
at least one outlet located between one of the plurality of intake valve openings and one of the plurality of exhaust valve openings; and
a plurality of cooling passages surrounding the plurality of intake and exhaust valve openings, and connecting the at least one inlet and the at least one outlet.
